(19) United States
(12) Patent Application Publication
(10) Pub. No.: US 2013/0318430 A1
(43) Pub. Date: Nov. 28, 2013

(54) Method for Creating and Publishing an Electronic Publication and Publishing System for Implementing the Method

(71) Applicant: Yi-Chih Lu, Taipei City (TW)

(72) Inventor: Yi-Chih Lu, Taipei City (TW)

(21) Appl. No.: 13/711,698

(22) Filed: Dec. 12, 2012

(30) Foreign Application Priority Data
May 25, 2012 (CN) 201210167584.2

(51) Int. Cl. G06F 17/22

(52) U.S. Cl. CPC G06F 17/2247
USPC 715/234

(57) ABSTRACT

A method for creating and publishing an electronic publication is to be implemented using a publishing system configured to provide a user-operating webpage incorporated with a client interface to a client-end device communicating with the publishing system. In the method, the publishing system is configured to receive at least one data packet that is uploaded from the client-end device, to convert the data packet into an electronic publication, to store the electronic publication, and to generate a browsing interface that is associated with the electronic publication. The browsing interface is embedded within a browsing webpage.

### CROSS-REFERENCE TO RELATED APPLICATION

This application claims priority of Chinese Application No. 201210167584.2, filed on May 25, 2012.

### BACKGROUND OF THE INVENTION

1. Field of the Invention

The invention relates to a publishing system and a method for creating and publishing an electronic publication.

2. Description of the Related Art

An electronic book (E-book) has become very popular because of a number of advantages it possesses. For example, an E-book does not take up space and is environment-friendly, and it requires considerably less resources (e.g., paper and water) to produce such an E-book. The E-book is also easier to store and more reliable to be preserved, since quality of the digitally stored content does not tend to deteriorate over time, while that of real paper does.

Some publishing software have been developed to aid authors in publishing the electronic publication. However, the publishing software must be installed into electronic devices of the authors, and the completed electronic publication typically needs specific viewer software to be properly displayed. Additional software may incur some drawbacks. For example, such software may become target of malicious programs (e.g., a Trojan horse) and thus will be a potential security threat. In addition, different versions of software must be developed in order to work in various operating systems of different electronic devices.

### SUMMARY OF THE INVENTION

Therefore, one object of the present invention is to provide a method for creating and publishing an electronic publication without requiring installation of additional software.

Accordingly, a method for creating and publishing an electronic publication of the present invention is to be implemented using a publishing system. The publishing system is configured to provide a user-operating webpage incorporated with a client interface to at least one client-end device communicating with the publishing system through a network. The method comprises the following steps of:

configuring the publishing system to receive at least one data packet that is uploaded from the client-end device via the client interface displayed on the user-operating webpage;

configuring the publishing system to convert the data packet into an electronic publication according to a user-setting layout; and

configuring the publishing system to store the electronic publication, and to generate a browsing interface associated with the electronic publication, and embedded within a browsing webpage.

Another object of the present invention is to provide a publishing system for implementing the abovementioned method.

Accordingly, a publishing system of the present invention is configured to provide a user-operating webpage incorporated with a client interface to at least one client-end device communicating with the publishing system through a network. The publishing system comprises a communication module, a processing module, a storage module, and a browser module.

The communication module is configured to communicate with the client-end device for receiving at least one data packet that is uploaded from the client-end device via the client interface displayed on the user-operating webpage.

The processing module is configured to process the data packet based on a user-setting layout and to convert the data packet processed thereby into the electronic publication.

The storage module is configured to store the electronic publication therein. The browser module is configured to generate a browsing interface. The browsing interface is associated with the electronic publication, and is embedded within a browsing webpage.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic block diagram of a preferred embodiment of a publishing system according to the invention;

FIG. 2 is a schematic view illustrating interaction between the publishing system and a plurality of client-end devices;

FIG. 3 is a schematic view illustrating a data packet in one of various formats;

FIG. 4 is a flowchart of a method for creating and publishing an electronic publication, according to the invention;

FIG. 5 is a schematic view illustrating operation of a communication module and a processing module of the publishing system;

FIG. 6 is a schematic view illustrating operation of a browsing module of the publishing system; and

FIG. 7 is an exemplary layout of a browsing interface that can be displayed on a third-party device for reading the electronic publication created by the publishing system.

### DETAILED DESCRIPTION OF THE PREFERRED EMBODIMENT

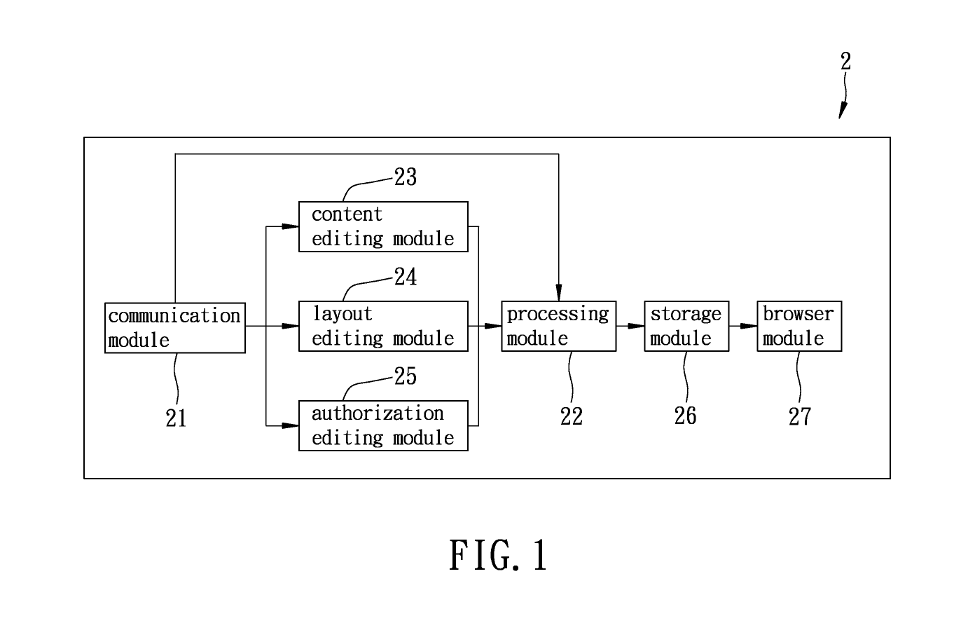

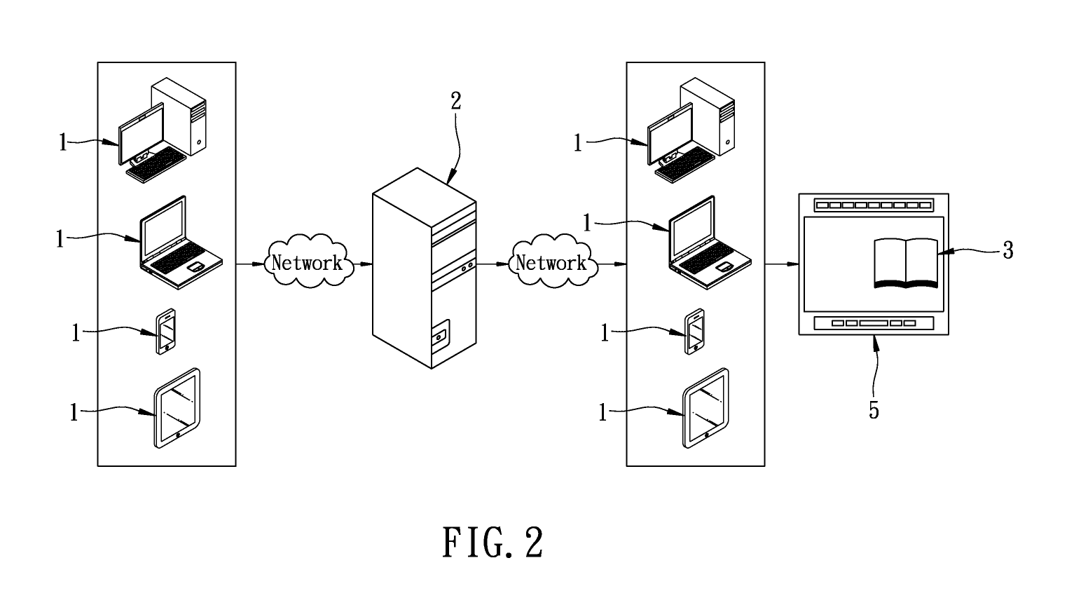

As shown in FIGS. 1 and 2, the preferred embodiment of a publishing system 2 according to the present invention is configured to communicate with a plurality of client-end devices 1 through a network, to provide a user-operating webpage incorporated with a client interface to the client-end devices 1, and to operate using cloud computing technology. The client-end devices 1 can be one of a computer, a laptop, a tablet computer, a mobile device and a personal digital assistant (PDA). The publishing system 2 can be a server-end device, and includes a communication module 21, a processing module 22, a content editing module 23, a layout editing module 24, an authorization editing module 25, a storage module 26, and a browser module 27.

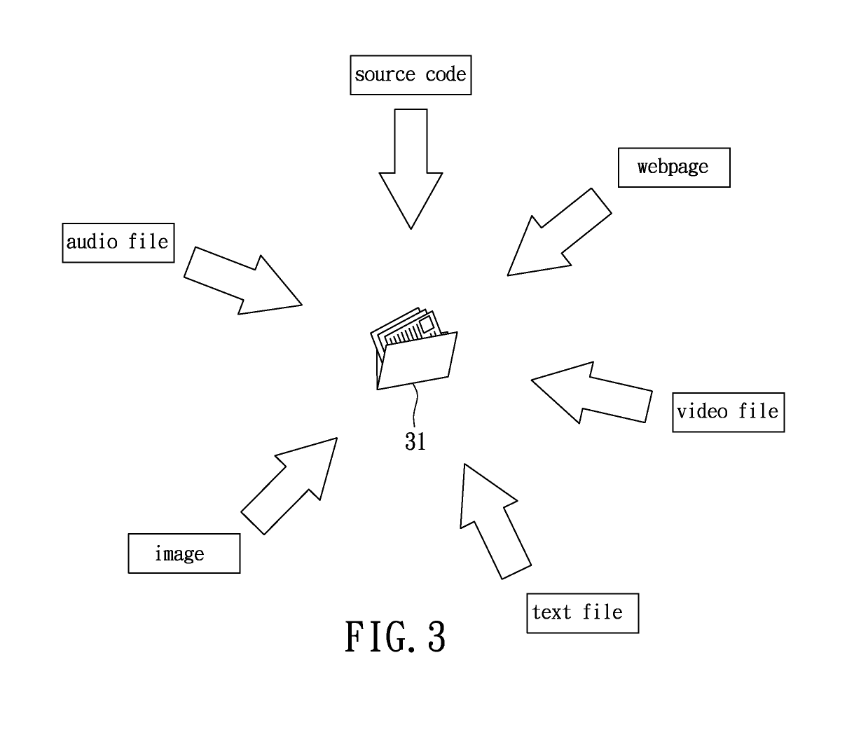

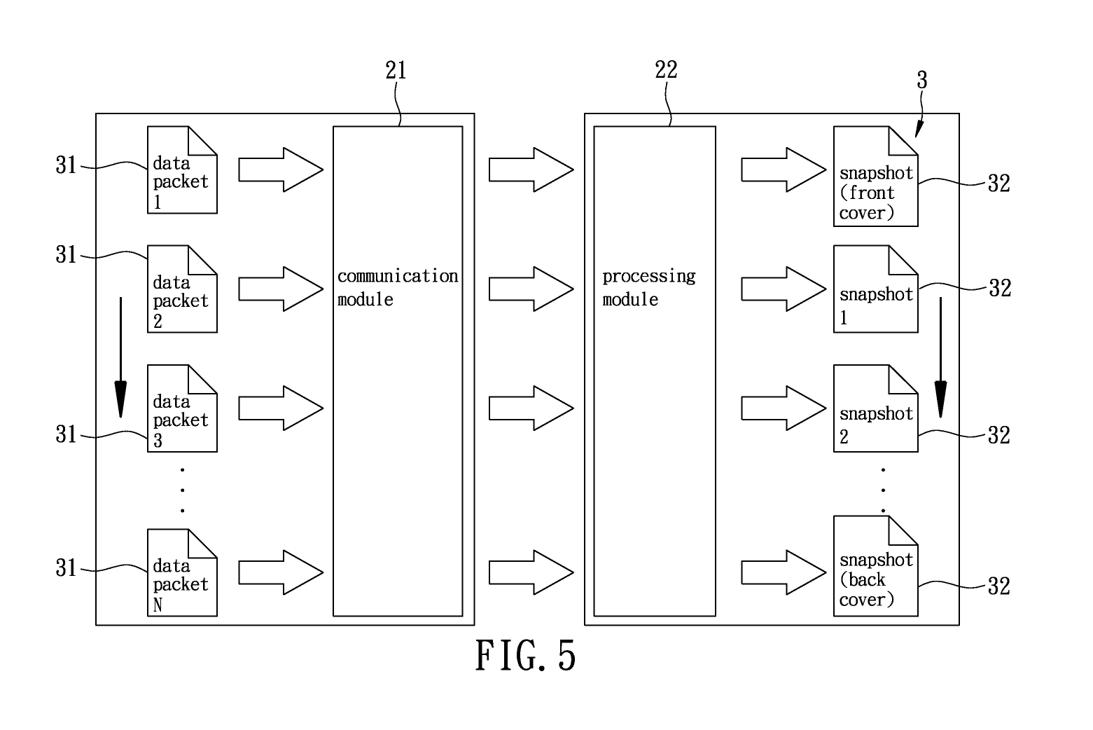

Further referring to FIG. 5, the communication module 21 is configured to receive a plurality of data packets 31 that are uploaded from the client-end devices via the client interface displayed on the user-operating webpage. In this embodiment, each of the data packets 31 is in a format of one of source code, an image, an audio file, a video file, a webpage and a text file (see FIG. 3).

The processing module 22 is configured to process the data packets 31 based on a user-setting layout and to merge and convert the data packets 31 processed thereby into an electronic publication 3. The content editing module 23 is configured to allow a user to assign content information associated with the electronic publication 3 using the client interface displayed on the user-operating webpage. In this embodiment, the content information includes at least one of a category, a title, an abstract, a synopsis and a keyword of the electronic publication 3.

The layout editing module 24 is configured to allow the user to set the user-setting layout using the client interface displayed on the user-operating webpage. The user-setting layout includes at least one of a layout size, a total number of pages, a background pattern, a page-turning direction, a color of text of the electronic publication 3, and an appearance of a browsing interface for reading the electronic publication 3.

The authorization editing module 25 is configured to allow the user to set, using the client interface displayed on the user-operating webpage, a publication authorization to be associated with the electronic publication 3. The publication authorization includes at least one of search setting indicating whether the electronic publication 3 is searchable, privacy setting indicating whether the electronic publication 3 is accessible to a third party, and comment setting indicating whether it is allowable to make a comment on the electronic publication 3. The authorization editing module 25 is further configured to determine a copyright on the electronic publication 3 belonging to the user associated with the client-end device 1 according to identification information of the user. The identification information includes an account name and a password associated with the account name, and is uniquely associated with the user of the client-end device 1.

The storage module 26 is configured to store the electronic publication 3 therein. In this embodiment, the storage module 26 may be a cloud storage.

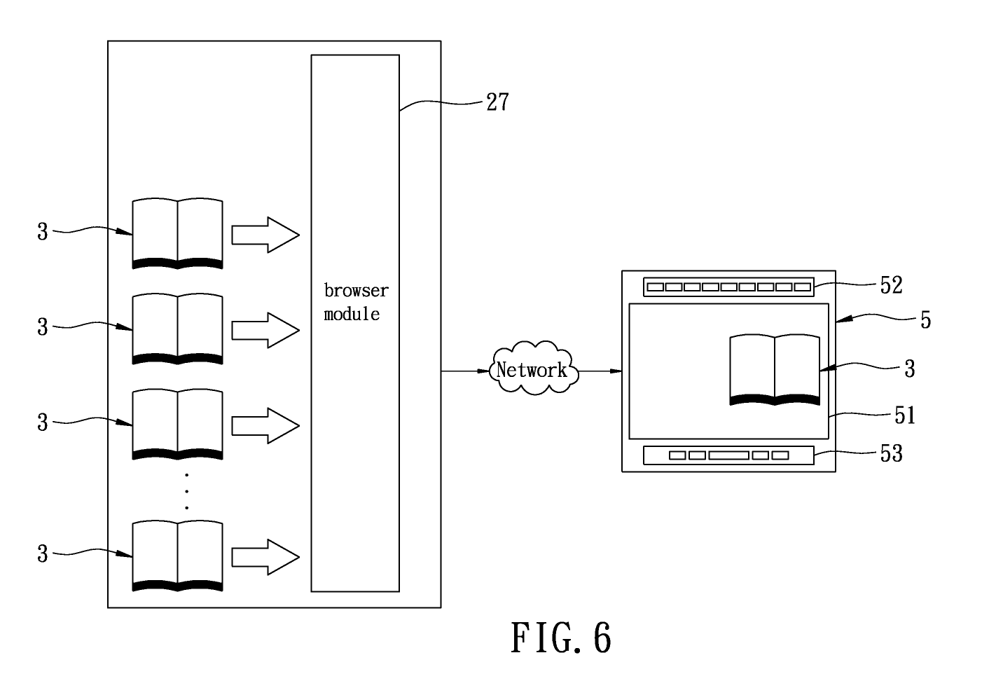

The browser module 27 is configured to generate a browsing interface 5 associated with the electronic publication 3, and embedded within a browsing webpage. A third party can be allowed to read the electronic publication 3 via the browsing webpage using a third-party electronic device 1′ that is connected to the publishing system 2 using through the network (as shown in FIG. 6).

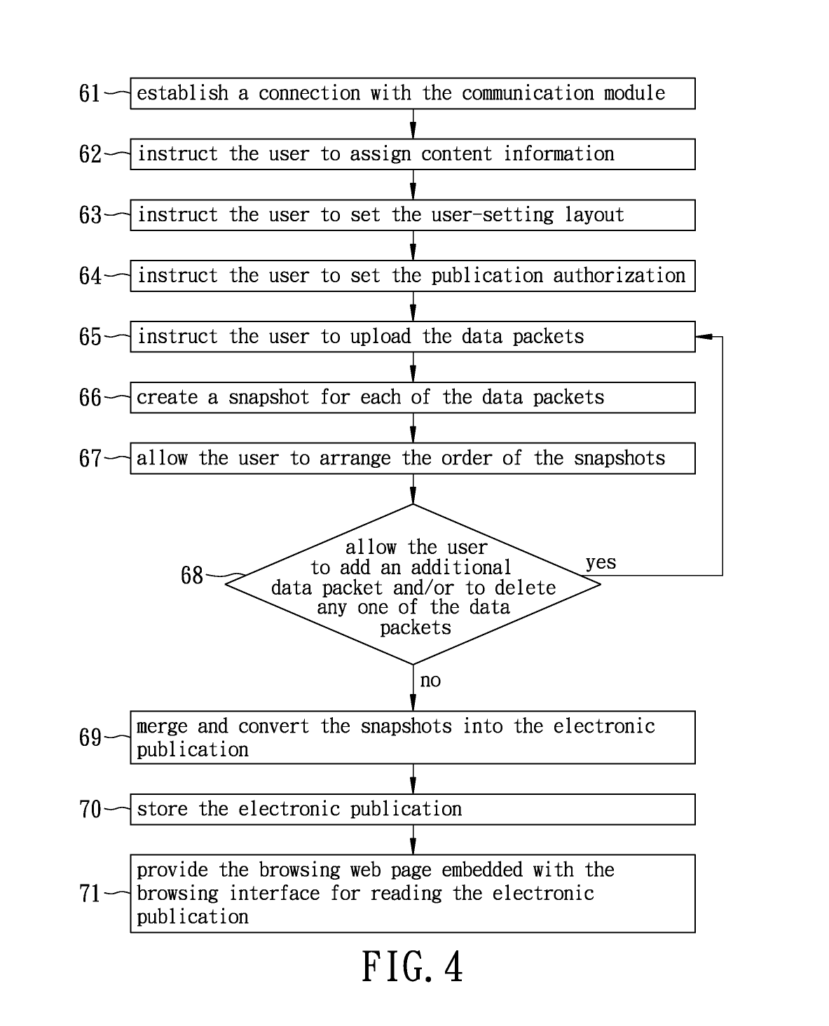

Further referring to FIG. 4, the succeeding paragraphs describe a method for creating and publishing the electronic publication 3 using the publishing system 2.

In step 61, the user controls operation of the client-end device 1 to establish a connection with the communication module 21 of the publishing system 2 through the network. Upon establishing connection, the publishing system 2 provides the user-operating webpage to be displayed by the client-end device 1. In this embodiment, the publishing system 2 supports websocket technology, and the client interface that is incorporated with the user-operating webpage can be constructed using one of extensible markup language (XML), personal home page (PHP), and active server pages (ASP).

In step 62, the content editing module 23 of the publishing system 2 instructs the user to assign content information to be associated with the electronic publication 3 using the client interface displayed on the user-operating webpage. Then, in step 63, the layout editing module 24 instructs the user to set the user-setting layout using the client interface. Afterward, in step 64, the authorization editing module 25 instructs the user to set, using the client interface displayed on the user-operating webpage, the publication authorization to be associated with the electronic publication 3. The authorization editing module 25 also determines the copyright on the electronic publication 3 according to the identification information of the user.

In step 65, the publishing system 2 instructs the user to upload the data packets 31 via the client interface, which are then received by the communication module 21.

Then, the processing module 22 is operable to create a snapshot 32 for each of the data packets 31 in step 66. When one of the data packets 31 includes multimedia files (e.g., video and/or audio files), the snapshot 32 includes a link directed to the multimedia files. Afterward, the processing module 22 is operable to display the snapshots 32 on the user-operating webpage, and to allow the user to arrange the order of the snapshots 32 of the data packets 31 via the client interface in step 67. Then, in step 68, the processing module 22 is operable to allow the user to add an additional data packet 31 and/or to delete any one of the data packets 31 via the client interface. When the user decides to further add a data packet 31, the flow goes back to step 65. Otherwise, the flow proceeds to step 69.

In step 69, according to the content information and the user-setting layout set respectively in steps 62 and 63, the processing module 22 is operable to merge and convert the snapshots 32 into the electronic publication 3 in the order as arranged by the user in step 67 (as shown in FIG. 5). Accordingly, the electronic publication 3 generated in step 69 has the content information and the user-setting layout that are set by the user.

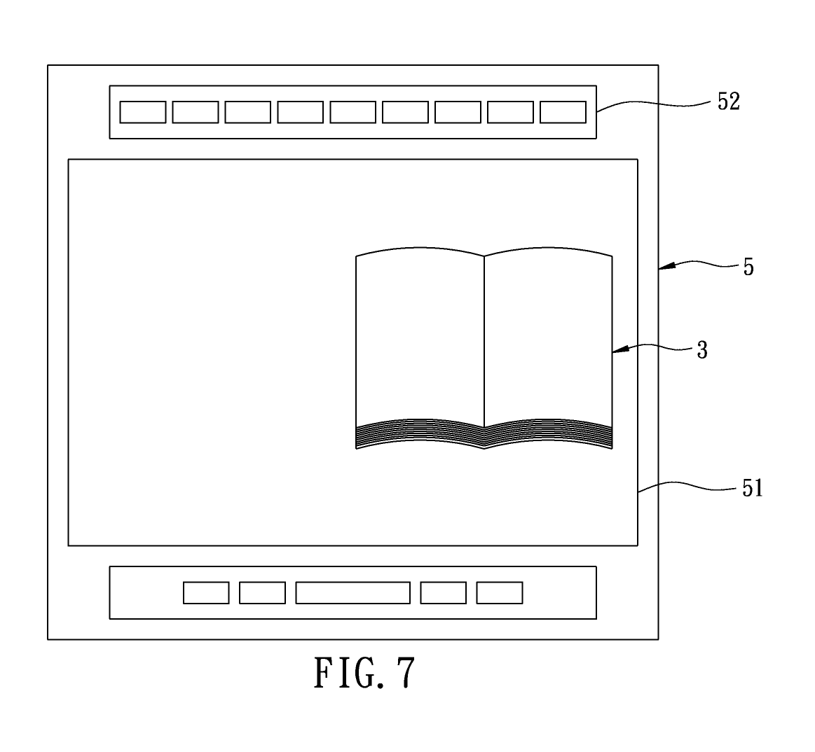

The electronic publication 3 is then stored in the storage module 26 in step 70. In step 71, the browser module 27 is operable to provide the browsing web page embedded with the browsing interface 5 for reading the electronic publication 3 with the publication authorization set in step 64. FIGS. 6 and 7 illustrate an exemplary browsing interface 5, including a desktop region 51 that is able to display the electronic publication 3, and a control panel 52. The browsing interface 5 allows the third party to browse the electronic publication 3 at the browsing webpage using the third-party electronic device 1′. In some examples, commercial advertisements may be embedded within the browsing interface 5. In some examples, the publishing system 2 may allow the user of the client-end device 1 to charge the third party for reading, and/or to allow previewing the electronic publication 3.

To sum up, the publishing system 2 of this invention is configured, such that the data packets 31 do not need to be transformed to other formats before being uploaded to the publishing system 2. As a result, the user of the client-end device 1 may create the electronic publication 3 with relative ease, and the client-end device 1 does not need to be installed with additional software therein, thereby preventing potential security threat. For the third party, since the browsing interface 5 is embedded into the browsing webpage, the electronic publication 3 can be read directly at the browsing webpage using a browser of the third-party electronic device 1′. As a result, reading can be made more convenient, and there is no requirement of installing additional software.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A method for creating and publishing an electronic publication, to be implemented using a publishing system that is configured to provide a user-operating webpage incorporated with a client interface to at least one client-end device communicating with the publishing system through a network, said method comprising the following steps of:
(a) configuring the publishing system to receive at least one data packet that is uploaded from the client-end device via the client interface displayed on the user-operating webpage;
(b)configuring the publishing system to convert the data packet into an electronic publication according to a user-setting layout; and
(c)configuring the publishing system to store the electronic publication, and to generate a browsing interface associated with the electronic publication, and embedded within a browsing webpage.

2. The method of claim 1, wherein the publishing system is operable to determine a copyright on the electronic publication belonging to a user associated with the client-end device according to identification information of the user.

3. The method of claim 2, wherein the identification information includes an account name and a password associated with the account name, and is uniquely associated with the user of the client-end device.

4. The method of claim 1, wherein the data packet is in a format of one of source code, an image, an audio file, a video file, a webpage and a text file.

5. The method of claim 1, wherein:
in step (a), the publishing system is configured to receive a plurality of data packets uploaded from the client-end device via the client interface; and
in step (b), the publishing system is configured to merge the data packets before converting the same.

6. The method of claim 5, wherein step (b) includes the following sub-steps of:
(b-1) configuring the publishing system to create a snapshot for each of the data packets, and to allow a user to add an additional data packet and/or to delete any one of the data packets via the client interface;
(b-2) configuring the publishing system to display the snapshots on the user-operating webpage, and to allow a user to arrange the order of the snapshots of the data packets via the client interface; and
(b-3) configuring the publishing system to merge and convert the snapshots in an order as arranged by the user in step (b-2).

7. The method of claim 1, further comprising, before step (c), a step of:
configuring the publishing system to allow a user to assign content information to be associated with the electronic publication, using the client interface displayed on the user-operating webpage, the content information including at least one of a category, a title, an abstract, a synopsis and a keyword of the electronic publication;
wherein, instep (b), the publishing system is further configured to merge the content information with the data packet and then to convert the data packet into the electronic publication.

8. The method of claim 1, further comprising, before step (c), a step of:
configuring the publishing system to allow a user to assign, using the client interface displayed on the user-operating webpage, a publication authorization to be associated with the electronic publication;
wherein the publication authorization includes at least one of search setting indicating whether the electronic publication is allowed to be searched, privacy setting indicating whether the electronic publication is accessible to a third party, and comment setting indicating whether it is allowable to make a comment on the electronic publication.

9. The method of claim 1, further comprising, before step (b), the step of:
configuring the publishing system to allow a user to set the user-setting layout using the client interface displayed on the user-operating webpage, the user-setting layout including at least one of a layout size, a total number of pages, a background pattern, a page-turning direction, a color of text of the electronic publication, and an appearance of the browsing interface.

10. A publishing system for creating and publishing an electronic publication, said publishing system being configured to provide a user-operating webpage incorporated with a client interface to at least one client-end device communicating with said publishing system through a network, said publishing system comprising:
a communication module configured to communicate with the client-end device for receiving at least one data packet that is uploaded from the client-end device via the client interface displayed on the user-operating webpage;
a processing module configured to process the data packet based on a user-setting layout and to convert the data packet processed thereby into the electronic publication;
a storage module configured to store the electronic publication therein; and
a browser module configured to generate a browsing interface associated with the electronic publication and embedded within a browsing webpage.

11. The publishing system of claim 10, wherein:
said communication module is configured to receive a plurality of data packets uploaded form the client-end device via the client interface; and
said processing module is further configured to merge the data packets before converting the same.

12. The publishing system of claim 11, wherein said processing module is further configured to:
create a snapshot for each of the data packets;
allow a user to add an additional data packet and/or to delete any one of the data packets via the client interface;
display the snapshots on the user-operating webpage, and to allow a user to arrange the order of the snapshots of the data packets via the client interface; and
merge and convert the snapshots in an order as arranged by the user.

13. The publishing system of claim 10, further comprising a content editing module that is configured to allow a user to assign content information to be associated with the electronic publication using the client interface displayed on the user-operating webpage, the content information including at least one of a category, a title, an abstract, a synopsis and a keyword of the electronic publication,
wherein said processing module is further configured to merge the content information with the data packet and then to convert the data packet into the electronic publication.

14. The publishing system of claim 10, further comprising an authorization editing module configured to allow a user to set, using the client interface displayed on the user-operating webpage, a publication authorization to be associated with the electronic publication, the publication authorization including at least one of search setting indicating whether the electronic publication is searchable, privacy setting indicating whether the electronic publication is accessible to a third party, and comment setting indicating whether it is allowable to make a comment on the electronic publication.

15. The publishing system of claim 14, wherein said authorization editing module is further configured to determine a copyright on the electronic publication belonging to a user associated with the client-end device according to identification information of the user, the identification information including an account name and a password associated with the account name, and being uniquely associated with the user of the client-end device.

16. The publishing system of claim 10, further comprising a layout editing module configured to allow a user to set the user-setting layout using the client interface displayed on the user-operating webpage, the user-setting layout including at least one of a layout size, a total number of pages, a background pattern, a page-turning direction, a color of text of the electronic publication, and an appearance of the browsing interface.
